(19) United States
(12) Patent Application Publication
(10) Pub. No.: US 2025/0180746 A1
(43) Pub. Date: Jun. 5, 2025

(54) TIME-OF-FLIGHT SENSING SYSTEM AND TIME-OF-FLIGHT SENSING METHOD

(71) Applicant: HIMAX TECHNOLOGIES LIMITED, Tainan City (TW)

(72) Inventors: Hsueh-Tsung Lu, Tainan City (TW); Wu-Feng Chen, Tainan City (TW)

(73) Assignee: HIMAX TECHNOLOGIES LIMITED, Tainan City (TW)

(21) Appl. No.: 18/525,808

(22) Filed: Nov. 30, 2023

(51) Int. Cl. G01S 17/894; G01S 7/481

(52) U.S. Cl. CPC G01S 17/894; G01S 7/4815; G01S 7/4816

(57) ABSTRACT

A time-of-flight sensing system including a first light source, a second light source, a sensing device and a filter layer is provided. The sensing device has a plurality of first sensing pixels and a plurality of second sensing pixels. The filter layer is disposed on a side of a light-receiving surface of the sensing device. The filter layer has a plurality of first filter patterns overlapping the first sensing pixels and a plurality of second filter patterns overlapping the second sensing pixels. The first light source and the second light source respectively and sequentially emit the first light beam having a first wavelength and the second light beam having a second wavelength toward a sensing target. The first sensing pixels and the second sensing pixels simultaneously and respectively sense the first light beam and the second light beam reflected from the sensing target. A time-of-flight sensing method is also provided.

### BACKGROUND

### Technical Field

This disclosure relates to a sensing technology, and in particularly, relates to a time-of-flight sensing system and a time-of-flight sensing method.

### Description of Related Art

With the rise of computer vision applications in various industries, various three-dimensional (3D) depth sensing technologies are booming. For example, a time-of-flight (ToF) ranging device is used in the general application of 3D depth sensing technology. Due to the high detection rate, small module size, low cost and high depth spatial resolution, an indirect time-of-flight (iToF) 3D depth sensing technology is widely used in fields such as robot vision and autonomous driving.

In general, the light source used in the iToF 3D depth sensing device is modulated by a continuous-wave, typically a sinusoid or square wave. The iToF 3D depth sensing method generally takes four samples per measurement with each sample phase-stepped by 90 degrees. However, due to the long sampling time, false sampling may occur when objects move in the scene, resulting in depth signal errors.

### SUMMARY

In view of the foregoing problems, the disclosure provides a time-of-flight sensing system and a time-of-flight sensing method capable of reducing the sampling time and improving the accuracy of measured depth or distance.

The disclosure provides a time-of-flight sensing system including a first light source, a second light source, a sensing device and a filter layer. The first light source is configured to emit a first light beam having a first wavelength toward a sensing target. The second light source is configured to emit a second light beam having a second wavelength toward the sensing target. The first wavelength of the first light beam is different from the second wavelength of the second light beam. The sensing device is configured to receive the first light beam and the second light beam reflected from the sensing target. The sensing device has a plurality of first sensing pixels and a plurality of second sensing pixels. The filter layer is disposed on a side of a light-receiving surface of the sensing device. The filter layer has a plurality of first filter patterns respectively overlapping the first sensing pixels and a plurality of second filter patterns respectively overlapping the second sensing pixels. The first filter patterns allow the first light beam to pass and block the second light beam. The second filter patterns allow the second light beam to pass and block the first light beam. The first light source and the second light source respectively and sequentially emit the first light beam and the second light beam. The first sensing pixels and the second sensing pixels simultaneously and respectively sense the first light beam and the second light beam.

The disclosure further provides a time-of-flight sensing method including the following steps: emitting a first light beam having a first wavelength by a first light source toward a sensing target, emitting a second light beam having a second wavelength by a second light source toward the sensing target after emitting the first light beam, and sensing the first light beam and the second light beam reflected from the sensing target simultaneously by a sensing device having a plurality of first sensing pixels and a plurality of second sensing pixels. The first wavelength and the second wavelength are different. A filter layer is disposed on a side of a light-receiving surface of the sensing device. The filter layer has a plurality of first filter patterns respectively overlapping the first sensing pixels and a plurality of second filter patterns respectively overlapping the second sensing pixels. The first filter patterns allow the first light beam to pass and block the second light beam. The second filter patterns allow the second light beam to pass and block the first light beam.

Based on the above, in the time-of-flight sensing system and the time-of-flight sensing method according to an embodiment of the disclosure, a first light source and a second light source are used to sequentially and respectively emit a first light beam and a second light beam toward a sensing target. The configuration of a filter layer enables the sensing device to simultaneously receive the first light beam and the second light beam having different wavelengths and reflected from the sensing target. Such that, the sampling time may be significantly shortened and a more accurate depth signal may be provided by the time-of-flight sensing system.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a time-of-flight sensing system according to a first embodiment of the disclosure.

FIG. 2A is a schematic diagram illustrating the arrangement of a first light source, a second light source and a sensing device according to the first embodiment of the disclosure.

FIG. 2B is a schematic diagram illustrating the arrangement of a first light source, a second light source and a sensing device according to a modified embodiment of the disclosure.

FIG. 3A is a schematic diagram illustrating the arrangement of a microlens array, a filter layer and a sensing device according to the first embodiment of the disclosure.

FIG. 3B is a schematic diagram illustrating the arrangement of a microlens array, a filter layer and a sensing device according to a modified embodiment of the disclosure.

FIG. 3C is a schematic diagram illustrating the arrangement of a microlens array, a filter layer and a sensing device according to another modified embodiment of the disclosure.

FIG. 4 is a schematic diagram of the sampling timing of the first embodiment of the disclosure.

FIG. 5 is a flow chart of a time-of-flight sensing method according to the first embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

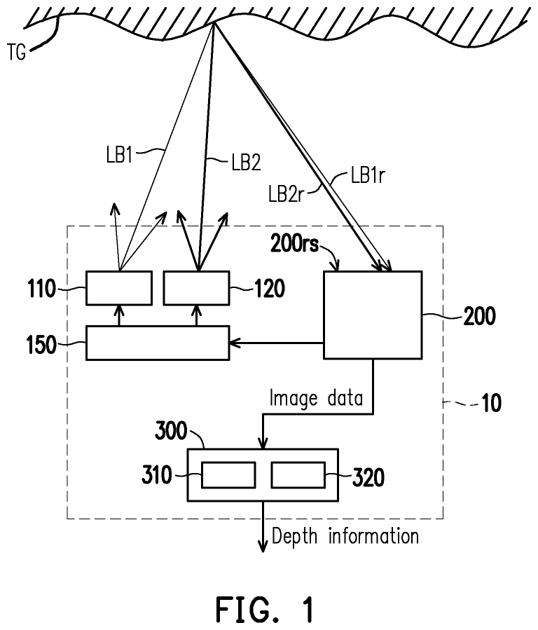

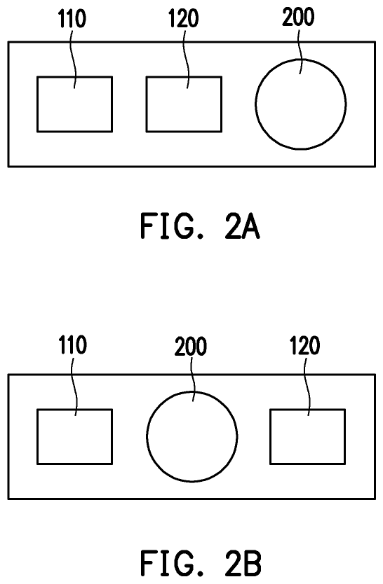

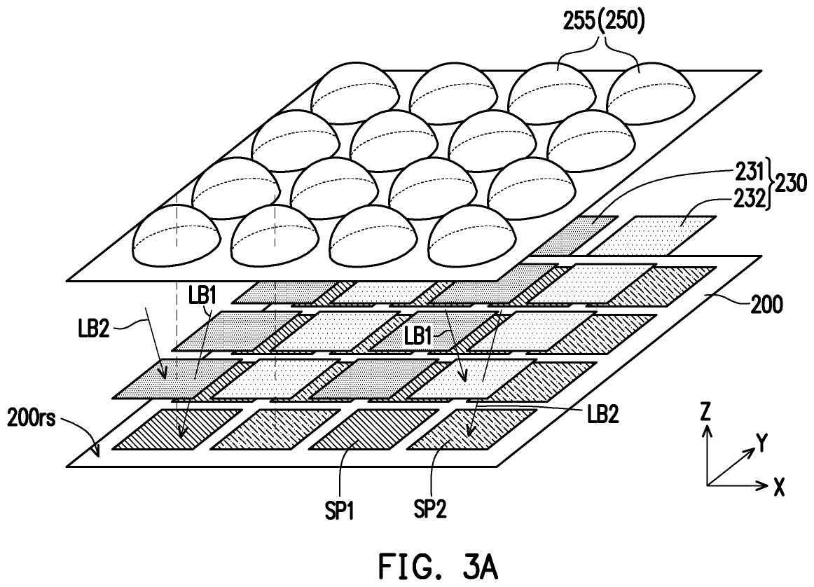

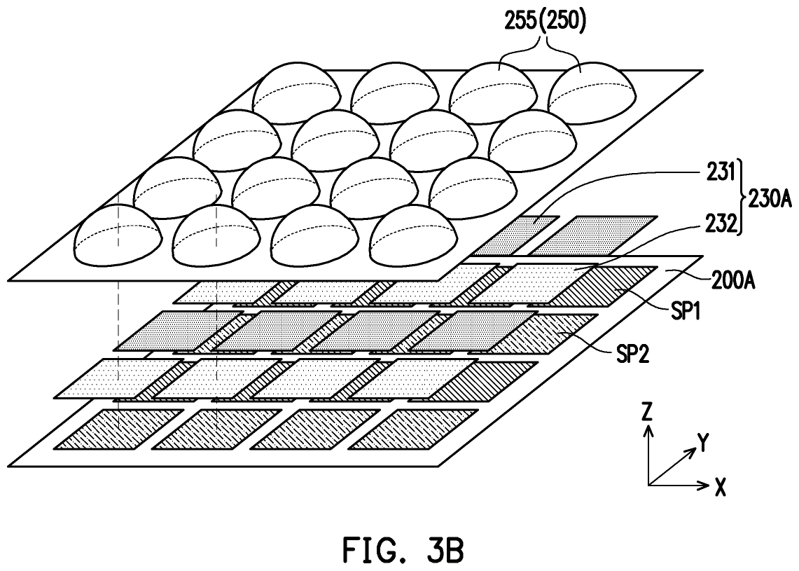

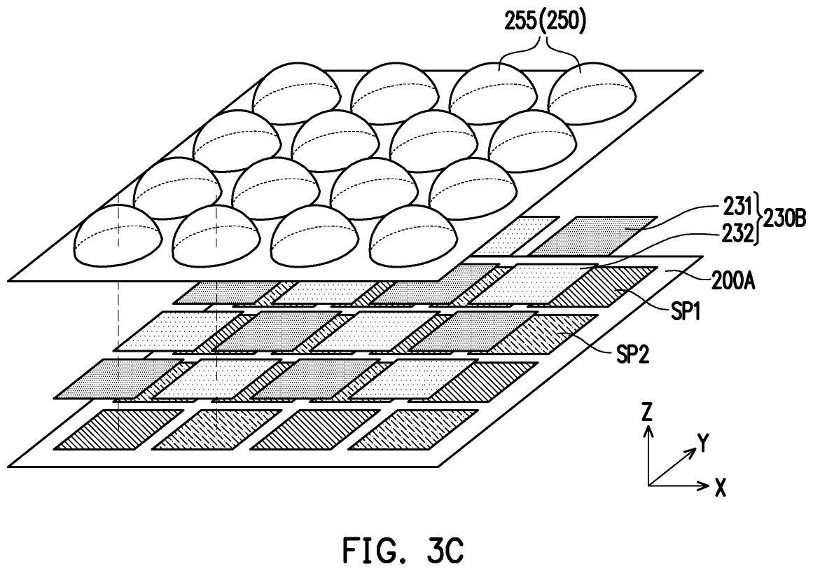

FIG. 1 is a schematic diagram of a time-of-flight sensing system according to a first embodiment of the disclosure. FIG. 2A is a schematic diagram illustrating the arrangement of a first light source, a second light source and a sensing device according to the first embodiment of the disclosure. FIG. 2B is a schematic diagram illustrating the arrangement of a first light source, a second light source and a sensing device according to a modified embodiment of the disclosure. FIG. 3A is a schematic diagram illustrating the arrangement of a microlens array, a filter layer and a sensing device according to the first embodiment of the disclosure. FIG. 3B is a schematic diagram illustrating the arrangement of a microlens array, a filter layer and a sensing device according to a modified embodiment of the disclosure. FIG. 3C is a schematic diagram illustrating the arrangement of a microlens array, a filter layer and a sensing device according to another modified embodiment of the disclosure.

Referring to FIG. 1, a time-of-flight sensing system 10 includes a first light source 110, a second light source 120 and a sensing device 200. The first light source 110 is configured to emit a first light beam LB1 having a first wavelength toward a sensing target TG. The second light source 120 is configured to emit a second light beam LB2 having a second wavelength toward the sensing target TG. The first wavelength of the first light beam LB1 is different from the second wavelength of the second light beam LB2.

A light source driver 150 may be provided and connected to the first light source 110, the second light source 120 and the sensing device 200. The light source driver 150 is configured to drive the first light source 110 and the second light source 120 to respectively and sequentially emit the first light beam LB1 and the second light beam LB2. In the present embodiment, the first light source 110 and the second light source 120 may be flood illuminators, but the disclosure is not limited thereto. In other embodiment, the first light source and the second light source may be speckle projectors.

A sensing device 200 is configured to receive the first light beam LB1 and the second light beam LB2 reflected from the sensing target TG. On the other hand, the sensing device 200 is also configured to synchronously control the light source driver 150 to drive the first light source 110 and the second light source 120.

Referring to FIG. 3A, the sensing device 200 has a plurality of first sensing pixels SP1 and a plurality of second sensing pixels SP2. The first sensing pixels SP1 are configured to sense the first light beam LB1, and the second sensing pixels SP2 are configured to sense the second light beam LB2. For example, the first sensing pixels SP1 and the second sensing pixels SP2 may be a plurality of single photon avalanche diodes (SPADs), but the disclosure is not limited thereto.

To prevent the first light beam LB1 from being received by the second sensing pixels SP2 and the second light beam LB2 from being received by the first sensing pixels SP1, a filter layer 230 is disposed on a side of a light-receiving surface 200rs of the sensing device 200. The filter layer 230 has a plurality of first filter patterns 231 and a plurality of second filter patterns 232.

The first filter patterns 231 respectively overlap the first sensing pixels SP1 of the sensing device 200 along the normal direction (for example, a direction Z) of the light-receiving surface 200rs. The second filter patterns 232 respectively overlap the second sensing pixels SP2 of the sensing device 200 along the normal direction of the light-receiving surface of the sensing device 200. The first filter patterns 231 allow the first light beam LB1 to pass and block the second light beam LB2. The second filter pattern 232 allow the second light beam LB2 to pass and block the first light beam LB1. For example, the filter layer 230 may be a bandpass filter.

In the present embodiment, the first sensing pixels SP1 and the second sensing pixels SP2 are alternately arranged along a direction X. Correspondingly, the first filter patterns 231 and the second filter patterns 232 are alternately arranged along the direction X. However, the disclosure is not limited thereto, in a modified embodiment, the first sensing pixels SP1 and the second sensing pixels SP2 of the sensing device 200A may be alternately arranged along a direction Y, and the first filter patterns 231 and the second filter patterns 232 of the filter layer 230A may be alternately arranged along the direction Y, correspondingly (as illustrated in FIG. 3B).

In another modified embodiment, the first sensing pixels SP1 and the second sensing pixels SP2 of the sensing device 200B may be alternately arranged along both the direction X and the direction Y, and the first filter patterns 231 and the second filter patterns 232 of the filter layer 230B may be alternately arranged along both the direction X and the direction Y, correspondingly (as illustrated in FIG. 3C). The direction X intersects the direction Y.

For example, in the present embodiment, the filter layer 230 may be formed on the light-receiving surface 200rs of the sensing device 200 through a lithography process or multilayer film coating method, but the disclosure is not limited thereto. The material of the filter layer 230 may include organic material.

In the present embodiment, the time-of-flight sensing system 10 may further include a microlens array 250 disposed on the side of the light-receiving surface 200rs of the sensing device 200. Specifically, the filter layer 230 is located between the microlens array 250 and the sensing device 200. For example, the microlens array 250 has a plurality of microlens 255, and the microlens 255 respectively overlap the first sensing pixels SP1 and the second sensing pixels SP2 of the sensing device 200, but the disclosure is not limited thereto. The configuration of the microlens array 250 may increase the light collection efficiency of the time-of-flight sensing system 10.

In the present embodiment, both the first light source 110 and the second light source 120 may be arranged on one side of the sensing device 200 (for example, the left side of the sensing device 200 in FIG. 2A), but the disclosure is not limited thereto. In other embodiment, the first light source 110 and the second light source 120 may be arranged on two opposite sides of the sensing device 200 (as illustrated in FIG. 2B).

Referring to FIG. 1 and FIG. 3A, further, the sensing device 200 is also configured to generate image data according to a plurality of sensing results of the first sensing pixels SP1 and the second sensing pixels SP2. The sensing results may be, for example, the electrical current converted from the photonic energy received by the sensing pixels of sensing device 200. The sensing device 200 may include a time-to-digital converter (not illustrated), and the sensing results of the sensing pixels are output to the time-to-digital converter. The time-to-digital converter may perform a plurality of times of integration operations on the sensing results of each of the sensing pixels to generate image data. The image data may be stored in a memory (not illustrated) of the sensing device 200 or a buffer of the time-to-digital converter.

The time-of-flight sensing system 10 may further include a processing circuit 300. The processing circuit 300 is electrically coupled to the sensing device 200, and is configured to generate a depth information of the sensing target TG according to the image data. In the present embodiment, the processing circuit 300 may include a microcontroller unit (MCU) 310 and a depth decoder 320. The microcontroller unit 310 may read out the image data and analyze the image data with the depth decoder 320.

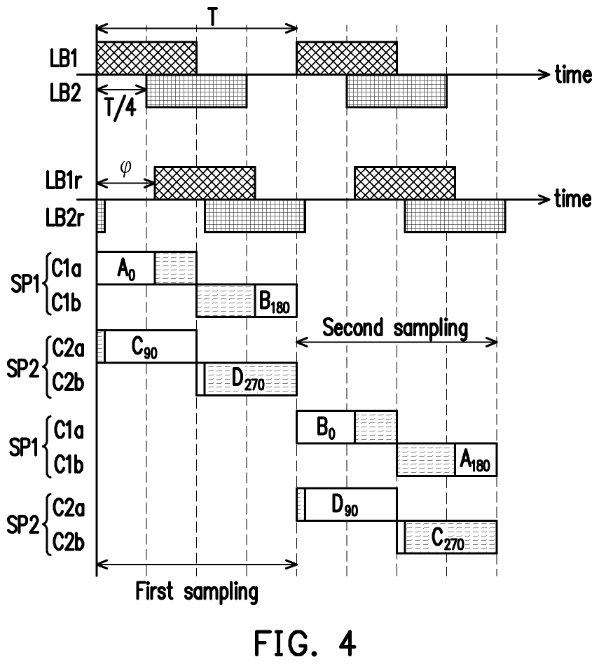

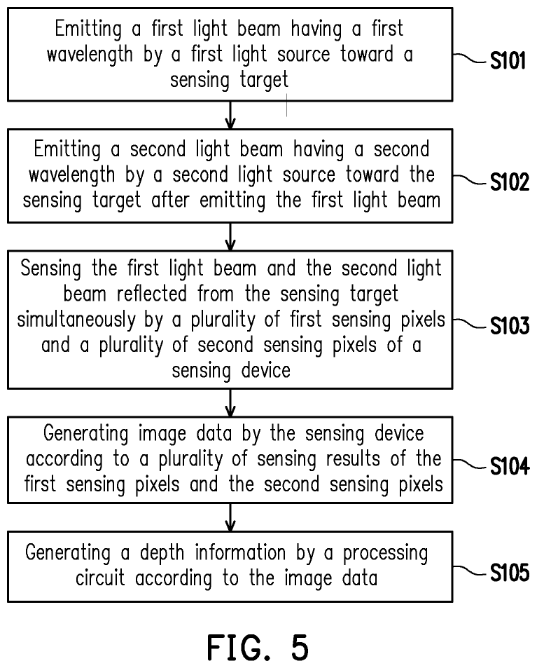

FIG. 4 is a schematic diagram of the sampling timing of the first embodiment of the disclosure FIG. 5 is a flow chart of a time-of-flight sensing method according to the first embodiment of the disclosure.

Referring to FIG. 1, FIG. 3A and FIG. 4, the depth decoder 320 is configured to calculate a phase angle φ between the first light beam LB1 emitted from the first light source 110 and the first light beam LB1r reflected from the sensing target TG according to the image data. The depth decoder 320 is also configured to generate the depth information of the sensing target TG according to the phase angle φ between the first light beam LB1 emitted from the first light source 110 and the first light beam LB1r reflected from the sensing target TG.

The following will exemplarily describe a sensing method of the time-of-flight sensing system 10. Firstly, emitting a first light beam LB1 having a first wavelength by the first light source 110 toward a sensing target TG (i.e. step S101 in FIG. 5). After emitting the first light beam LB1, emitting a second light beam LB2 having a second wavelength by the second light source 120 toward the sensing target TG (i.e. step S102 in FIG. 5). The first wavelength is different from the second wavelength.

For example, each of the first light beam LB1 and the second light beam LB2 is modulated with a period T, and the second light beam LB2 emitted from the second light source 120 is delayed by one quarter of the period (T/4) relative to the first light beam LB1 emitted from the first light source 110 (as illustrated in FIG. 4).

After emitting the second light beam LB2, sensing the first light beam LB1r and the second light beam LB2r reflected from the sensing target TG simultaneously by the first sensing pixels SP1 and the second sensing pixels SP2 of the sensing device 200 (i.e. step S103 in FIG. 5). A plurality of sensing results is generated by the sensing pixels after receiving the light beams reflected from the sensing target TG.

In the present embodiment, each of the sensing pixels may include two capacitors, and the two capacitors charge in different half-cycles of one sampling period. For example, each of the first sensing pixels SP1 may be provided with a first capacitor C1a and a second capacitor C1b, and each of the second sensing pixels SP2 may be provided with a first capacitor C2a and a second capacitor C2b. In the present embodiment, the sampling period of the sensing pixel is equal to the modulation period (T) of the first light beam LB1 and the second light beam LB2.

The sensing process may include at least a first sampling and a second sampling. During each period of the first sampling and the second sampling, electrical charges accumulated in each of the capacitors of the sensing pixels are measured as sensing results. Compared to prior 3D depth sensing method generally taking four samples per measurement with each sample phase-stepped by 90 degrees, the time-of-flight sensing method of present embodiment only takes two samples per measurement. Therefore, the sampling time of present embodiment may be significantly shortened and a more accurate depth information may be provided by the time-of-flight sensing system 10.

The time-of-flight sensing method may further include generating image data by the sensing device 200 according to a plurality of sensing results of the first sensing pixels SP1 and the second sensing pixels SP2 (i.e. step S104 in FIG. 5). For example, the time-to-digital converter aforementioned may perform a plurality of times of integration operation on the sensing results from the sensing pixels during a plurality of consecutive integration periods to generate image data.

The time-of-flight sensing method may further include generating a depth information by a processing circuit 300 according to the image data (i.e. step S105 in FIG. 5). In the present embodiment, the step of generating the depth information may includes calculating a phase angle q between the first light beam LB1 emitted from the first light source 110 and the first light beam LB1r reflected from the sensing target TG according to the image data.

For example, during the first sampling period, the electrical charges accumulated in the first capacitor C1a, the second capacitor C1b, the first capacitor C2a and the second capacitor C2b are respectively measured as A₀, B₁₈₀, C₉₀ and D₂₇₀. During the second sampling period, the electrical charges accumulated in the first capacitor C1a, the second capacitor C1b, the first capacitor C2a and the second capacitor C2b are respectively measured as B₀, A₁₈₀, D₉₀ and C₂₇₀. The phase angle φ is calculated by the following equation:

$$φ = {tan}^{- 1} ( \frac{{Q}_{1} - {Q}_{3}}{{Q}_{0} - {Q}_{2}} ) ,$$

wherein Q₀=A₀−B₁₈₀, Q₁=C₉₀−D₂₇₀, Q₂=A₁₈₀−B₀ and Q₃=C₂₇₀−D₉₀.

Then, calculating the distance (d; i.e. depth information) between the sensing target TG and the time-of-flight sensing system 10 by equation d=cTφ/(4π), wherein, c is the speed of light, and T is the modulation period of the first light beam LB1 and the second light beam LB2. The depth/distance measurement of the sensing target TG using the time-of-flight sensing method is completed herein. In the present embodiment, the calculation of the phase angle φ and the depth information may be performed by the depth decoder 320 of the processing circuit 300.

It should be noted that, in the embodiment, although the number of types of light sources with different output wavelengths is exemplified by taking two as an example, it does not mean that the disclosure is limited to this. In other embodiments, the number of types of light source may be three or more, and the number of types of the filter patterns may also be adjusted accordingly.

In summary, in the time-of-flight sensing system and the time-of-flight sensing method according to an embodiment of the disclosure, a first light source and a second light source are used to sequentially and respectively emit a first light beam and a second light beam toward a sensing target. The configuration of a filter layer enables the sensing device to simultaneously receive the first light beam and the second light beam having different wavelengths and reflected from the sensing target. Such that, the sampling time may be significantly shortened and a more accurate depth signal may be provided by the time-of-flight sensing system.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A time-of-flight sensing system, comprising:
a first light source, configured to emit a first light beam having a first wavelength toward a sensing target;
a second light source, configured to emit a second light beam having a second wavelength toward the sensing target, wherein the first wavelength of the first light beam is different from the second wavelength of the second light beam;
a sensing device, configured to receive the first light beam and the second light beam reflected from the sensing target, the sensing device has a plurality of first sensing pixels and a plurality of second sensing pixels; and
a filter layer, disposed on a side of a light-receiving surface of the sensing device, the filter layer has a plurality of first filter patterns respectively overlapping the first sensing pixels and a plurality of second filter patterns respectively overlapping the second sensing pixels, the first filter patterns allow the first light beam to pass and block the second light beam, and the second filter patterns allow the second light beam to pass and block the first light beam,
wherein the first light source and the second light source respectively and sequentially emit the first light beam and the second light beam, and the first sensing pixels and the second sensing pixels simultaneously and respectively sense the first light beam and the second light beam.

2. The time-of-flight sensing system according to claim 1, wherein each of the first light beam and the second light beam is modulated with a period, and the second light beam emitted from the second light source is delayed by one quarter of the period relative to the first light beam emitted from the first light source.

3. The time-of-flight sensing system according to claim 1, further comprising:
a light source driver, electrically coupled to the sensing device, the first light source and the second light source, the light source driver is configured to drive the first light source and the second light source to emit the first light beam and the second light beam sequentially.

4. The time-of-flight sensing system according to claim 1, wherein the sensing device is also configured to generate image data according to a plurality of sensing results of the first sensing pixels and the second sensing pixels.

5. The time-of-flight sensing system according to claim 4, further comprising:
a processing circuit, electrically coupled to the sensing device, and is configured to generate a depth information of the sensing target according to the image data.

6. The time-of-flight sensing system according to claim 5, wherein the processing circuit includes a depth decoder, configured to calculate a phase angle between the first light beam emitted from the first light source and the first light beam reflected from the sensing target according to the image data.

7. The time-of-flight sensing system according to claim 1, wherein the first filter patterns and the second filter patterns are alternately arranged along a first direction.

8. The time-of-flight sensing system according to claim 7, wherein the first filter patterns and the second filter patterns are alternately arranged along a second direction, and the first direction intersects the second direction.

9. The time-of-flight sensing system according to claim 1, further comprising:
a microlens array, disposed on the side of the light-receiving surface of the sensing device, wherein the filter layer is located between the microlens array and the sensing device.

10. The time-of-flight sensing system according to claim 1, wherein the filter layer is a bandpass filter.

11. The time-of-flight sensing system according to claim 1, wherein the first light source and the second light source are flood illuminators or speckle projectors.

12. A time-of-flight sensing method, comprising:
emitting a first light beam having a first wavelength by a first light source toward a sensing target;
emitting a second light beam having a second wavelength by a second light source toward the sensing target after emitting the first light beam, wherein the first wavelength and the second wavelength are different; and
sensing the first light beam and the second light beam reflected from the sensing target simultaneously by a plurality of first sensing pixels and a plurality of second sensing pixels of a sensing device,
wherein a filter layer is disposed on a side of a light-receiving surface of the sensing device, the filter layer has a plurality of first filter patterns respectively overlapping the first sensing pixels and a plurality of second filter patterns respectively overlapping the second sensing pixels, the first filter patterns allow the first light beam to pass and block the second light beam, and the second filter patterns allow the second light beam to pass and block the first light beam.

13. The time-of-flight sensing method according to claim 12, further comprising:
generating image data by the sensing device according to a plurality of sensing results of the first sensing pixels and the second sensing pixels.

14. The time-of-flight sensing method according to claim 13, further comprising:
generating a depth information by a processing circuit according to the image data, wherein the processing circuit is electrically coupled to the sensing device.

15. The time-of-flight sensing method according to claim 14, wherein the step of generating the depth information includes calculating a phase angle between the first light beam emitted from the first light source and the first light beam reflected from the sensing target according to the image data.

16. The time-of-flight sensing method according to claim 12, wherein each of the first light beam and the second light beam is modulated with a period, and the second light beam emitted from the second light source is delayed by one quarter of the period relative to the first light beam emitted from the first light source.
